(19) United States
(12) Patent Application Publication
(10) Pub. No.: US 2026/0189729 A1
(43) Pub. Date: Jul. 2, 2026

(54) RATE CONTROL METHOD FOR 360° VIDEO CODING

(71) Applicant: City University of Hong Kong, Kowloon (HK)

(72) Inventors: Shiqi WANG, Hong Kong (HK); Zeming ZHAO, Hong Kong (HK); Peilin CHEN, Hong Kong (HK)

(21) Appl. No.: 19/400,702

(22) Filed: Nov. 25, 2025

Related U.S. Application Data
(60) Provisional application No. 63/725,916, filed on Nov. 27, 2024.

(51) Int. Cl. H04N 19/597; H04N 19/147; H04N 19/162; H04N 19/172; H04N 19/19; H04N 19/593; H04N 19/96

(52) U.S. Cl. CPC H04N 19/597; H04N 19/147; H04N 19/162; H04N 19/172; H04N 19/19; H04N 19/593; H04N 19/96

(57) ABSTRACT

A rate control method for 360° videos coding. The method includes the steps of: a) converting a 360° video from a sphere domain to a plane domain to obtain two-dimensional (2D) plane video; b) extracting latitude information from the 2D plane video; c) adjusting strip-level allocated bits of the 2D plane video with the latitude information; each strip comprising Coding Tree Units (CTUs) in one row; d) identifying key CTU indices of each frame of the 2D plane video based on gaze points; and e) optimizing a CTU-level coding parameter based on the key CTU indices and a distortion dependency. Such a method results in improved rate-distortion performance.

### FIELD OF INVENTION

This invention relates to video coding methods, and in particular to rate control schemes for 360° video.

### BACKGROUND OF INVENTION

In the past few years, 360° video has started to infiltrate various aspects of daily life. Although there have been significant developments in 360° video coding technology, understanding of the human visual gaze mechanism has been somewhat overlooked. The 360° video is generally represented with a spherical model to encompass information of the entire environment. Therefore, it is typically featured with 4K or higher resolution with a high frame rate, guaranteeing a satisfactory viewing experience. These impose unprecedented challenges in transmitting and storing high volume 360° video data. In recent years, a series of video coding standards have been developed, including H.264/Advanced Video Coding (AVC) [1], H.265/High-Efficiency Video Coding (HEVC) [2], and the most recent H.266/Versatile Video Coding (VVC) [3]. Based on these standards, many optimization algorithms have also been studied to pursue enhanced rate-distortion performance [4]-[6]. However, these mainstream video compression schemes are mainly designed for 2D videos. Although 360° videos are typically transmitted and stored in 2D for ease of processing, the distinction in gaze mechanism enables more efficient coding approaches.

In contrast to 2D videos, human eyes cannot simultaneously observe the whole scene when viewing 360° video due to its high resolution and spherical distribution. Better understanding of the spatial and temporal characteristics and human visual gaze mechanism of 360° video is crucial for achieving an optimized rate-distortion performance when compressing 360° videos. Typically, the human visual gaze mechanism includes spatial and temporal gaze behaviors. Regarding spatial gaze behavior, human eyes focus more on regions around the equator in a spherical model, corresponding to the flat view. Essentially, regions near the equator contain more spatial significance for the human visual gaze mechanism compared to polar regions [7]. Meanwhile, 360° videos inherently rely on temporal dynamics, driving human eyes to shift their gaze region over time. Generating a realistic and time-dependent gaze trajectory can inspire a better understanding of temporal gaze behavior [8], thus providing new paths and informative clues for improving the coding efficiency of 360° videos.

Rate control (RC), which is a pivotal component for the application of video coding, has been delicately designed and deployed in commercial codecs, as well as in the VVC Test Model (VTM) [9], with the goal of delivering optimized coding performance under constrained bandwidth. In the 360° video coding scenario, the rate control scheme is indispensable for high-efficiency coding and transmission. Nevertheless, only a few rate control and optimization schemes have been investigated for 360° videos. The absence of consideration of spatial and temporal gaze behaviors in coding overlooks a crucial aspect of the human visual gaze mechanism. Therefore, developing a rate control for 360° videos is an urgent and challenging task.

### REFERENCES

Each of the following references (and associated appendices and/or supplements) is expressly incorporated herein by reference in its entirety:
[1] T. Wiegand, G. J. Sullivan, G. Bjøntegaard and A. Luthra, “Overview of the H.264/AVC video coding standard,” IEEE Trans. Circuits Syst. Video Technol., vol. 13, no. 7, pp. 560-576, July 2003.
[2] G. J. Sullivan, J.-R. Ohm, W.-J. Han and T. Wiegand, “Overview of the high efficiency video coding (HEVC) standard,” IEEE Trans. Circuits Syst. Video Technol., vol. 22, no. 12, pp. 1649-1668 December 2012.
[3] B. Bross, Y. Wang, Y. Ye, S. Liu, J. Chen, G. Sullivan and J.-R. Ohm, “Overview of the versatile video coding (VVC) standard and its applications,” IEEE Trans. Circuits Syst. Video Technol., vol. 31, no. 10, pp. 3736-3764 October 2021.
[4] T. Zhao, Y. Huang, W. Feng, Y. Xu and S. Kwong, “Efficient VVC Intra Prediction Based on Deep Feature Fusion and Probability Estimation,” IEEE Trans. Multimedia., vol. 25, pp. 6411-6421 September 2022.
[5] M. H. Hyun, B. Lee and M. Kim, “A VVC Intra Rate Control With Small Bit Fluctuations Using a Lagrange Multiplier Adjustment,” IEEE Trans. Multimedia., vol. 26, pp. 6811-6821 January 2024.
[6] S. He, D. Xu, L. Yang and W. Liang, “Adaptive HEVC Video Steganography With High Performance Based on Attention-Net and PU Partition Modes,” IEEE Trans. Multimedia., vol. 26, pp. 687-700, April 2024.
[7] Z. Zhao, X. He, S. Xiong, L. He and R. E. Sheriff, “An optimized rate control algorithm in versatile video coding for 360° videos,” IEEE Signal Process. Lett., vol. 29, pp. 2303-237 November 2022.
[8] X. Sui, Y. Fang, H. Zhu, S. Wang and Z. Wang, “ScanDMM: a deep Markov model of scanpath prediction for 360° images,” in 2023 IEEE/CVF Conference on Computer Vision and Pattern Recognition (CVPR), Vancouver, BC, Canada, 2023, pp. 6989-6999.
[9] “VVC software VTM-19.0.” Accessed: Nov. 30, 2022. [Online]. Available: https://vcgit.hhi.fraunhofer.de/jvet/VVCSoftware VTM/-/tree/VTM-19.0/
[10] “360Lib 13.4.” Accessed: Jan. 7, 2023. [Online]. Available: https://vcgit.hhi.fraunhofer.de/jvet/360lib/-/tree/360Lib-13.4?ref type=tags
[11] Y. He, J. Boyce, K. Choi and J. Lin, “JVET common test conditions and evaluation procedures for 360° video,” in Joint Video Experts Team (JVET) of ITU-T SG 16 WP 3 and ISO/IEC JTC 1/SC 29, Teleconference, January 2021, pp. 1-7.
[12] M. Yu, H. Lakshman, and B. Girod, “A framework to evaluate omnidirectional video coding schemes,” in Proc. IEEE Int. Symp. Mixed Augmented Reality, September 2015, pp. 31-36.
[13] H. Tran, N. Ngoc, C. Bui, M. H. Pham and T. C. Thang, “An evaluation of quality metrics for 360 videos,” in Proc. 9th Int. Conf. Ubiquitous Future Netw., July 2017, pp. 7-11.
[14] X. Corbillon, G. Simon, A. Devlic and J. Chakareski, “Viewport-adaptive navigable 360-degree video delivery,” in Proc. IEEE Int. Conf. Commun., May. 2017, pp. 1-7.
[15] M. Bevilacqua, A. Roumy, C. Guillemot and M.-L. Alberi Morel, “Single-image super-resolution via linear mapping of interpolated self-examples,” IEEE Trans. Image Process., vol. 23, no. 12, pp. 5334-5347 December 2014.
[16] K.-T. Ng, S.-C. Chan, and H.-Y. Shum, “Data compression and transmission aspects of panoramic videos,” IEEE Trans. Circuits Syst. Video Technol., vol. 15, no. 1, pp. 82-95, January 2005.
[17] J. J. Bai and X. S. Zhao, “Quadtree-based indexing of hierarchical diamond subdivisions of the global,” in Proc. IEEE Int. Geosci. Remote Sens. Symp., September 2004, vol. 5, pp. 2878-2881.
[18] K. K. Sreedhar, A. Aminlou, M. M. Hannuksela and M. Gabbouj, “Viewport-adaptive encoding and streaming of 360-degree video for virtual reality applications,” in Proc. IEEE Int. Symp. Multimedia, December 2016, pp. 583-586.
[19] Y.-W. Huang, J. An, H. Huang, X. Li, S-T. Hsiang, H. Gao, J. Ma and O. Chubach, “Block partitioning structure in the VVC standard,” IEEE Trans. Circuits Syst. Video Technol., vol. 31, no. 10, pp. 3818-3833 October 2021.
[20] L. Zhang, K. Zhang, H. Liu, HC. Chuang, Y. Wang, J. Xu, P. Zhao and D. Hong, “History-based motion vector prediction in versatile video coding,” in Proc. Data Compress. Conf. (DCC), March 2019, pp. 43-52.
[21] S. De-Lux′ an-Hern′ andez, V. George, J. Ma, T. Nguyen, H. Schwarz, D. Marpe and T. Wiegand, “An intra subpartition coding mode for VVC,” in Proc. IEEE Int. Conf. Image Process. (ICIP), September 2019, pp. 1203-1207.
[22] K. Zhang, Y.-W. Chen, L Zhang, W.-J. Chien and M. Karczewicz, “An improved framework of affine motion compensation in video coding,” IEEE Trans. Image Process., vol. 28, no. 3, pp. 1456-1469 March 2019.
[23] H. Schwarz, T. Nguyen, D. Marpe, and T. Wiegand, “Hybrid video coding with trellis-coded quantization,” in Proc. Data Compress. Conf. (DCC), March 2019, pp. 182-191.
[24] A. J. Viterbi, “Error bounds for convolutional codes and an asymptotically optimum decoding algorithm,” IEEE Trans. Inf. Theory, vol. IT-13, no. 2, pp. 260-269, April 1967.
[25] C. Shih, J. Lin, H. Lin, S.Chang and C. Ju, “360°-based inter/intra prediction for cubemap projection,” in Joint Video Experts Team (JVET) of ITU-T SG 16 WP 3 and ISO/IEC JTC 1/SC 29/WG 11, Ljubljana, Slovenia, July 2018, pp. 1-4.
[26] S. Lin, L. Liu, C. Hsuan, J. Lin, H. Lin, S. Chang and C. Ju, “360°-based in-loop filters for cubemap projection,” in Joint Video Experts Team (JVET) of ITU-T SG 16 WP 3 and ISO/IEC JTC 1/SC 29/WG 11, Ljubljana, Slovenia, July 2018, pp. 1-7.
[27] Hendry, “Adaptive QP for 360° video ERP projection,” in Joint Video Experts Team (JVET) of ITU-T SG 16 WP 3 and ISO/IEC JTC 1/SC 29/WG 11,Hobart, AU, April 2017, pp. 1-4.
[28] L. Li, B. Li, H. Li and C. W. Chen, “@-domain optimal bit allocation algorithm for high efficiency video coding,” IEEE Trans. Circuits Syst. Video Technol., vol. 28, no. 1, pp. 130-142, January 2018.
[29] Z. Zhao, X. He, S. Xiong, L. He, H. Chen and R. E. Sheriff, “A high-performance rate control algorithm in versatile video coding based on spatial and temporal feature complexity,” IEEE Trans. Broadcast., vol. 69, no. 3, pp. 753-766, September 2023.
[30] Y. Zhou, L. Tian, C. Zhu, X. Jin and Y. Sun, “Video coding optimization for virtual reality 360-degree source,” IEEE Journal of Selected Topics in Signal Processing., vol. 14, no. 1, pp. 118-129, January 2020.
[31] L. Li, N. Yan, Z. Li, S. Liu and H. Li, “@-domain perceptual rate control for 360-degree video compression,” IEEE J. Sel. Topics Signal Process., vol. 14, no. 1, pp. 130-145, January 2020.
[32] Y. Liu, M. Xiu, C. Li, S. Li and Z. Wang, “A novel rate control scheme for panoramic video coding,” in IEEE International Conference on Multimedia and Expo (ICME), Hong Kong, CN, July 2017, pp. 691-696.
[33] J. Hou, H. Guo, Y. Liu, L. Feng, X. Yang, L. Luo and C. Zhu, “Latitude-guided temporally dependent rate-distortion optimization for panoramic video coding,” in 2023 IEEE International Symposium on Broadband Multimedia Systems and Broadcasting (BMSB)., 2023, pp. 1-5.
[34] R. Krishnan, U. Shalit, and D. Sontag, “Structured inference networks for nonlinear state space models,” in AAAI Conference on Artificial Intelligence, vol. 31, 2017.
[35] H. Guo, C. Zhu, M. Xu and S. Li, “Inter-block dependency-based CTU level rate control for HEVC,” IEEE Transactions on Broadcasting., vol. 66, no. 1, pp. 113-126, March 2020.
[36] S. Li, C. Zhu, Y. Gao, Y. Zhou, F. Dufaux and M.-T. Sun, “Lagrangian multiplier adaptation for rate-distortion optimization with inter-frame dependency,” IEEE Trans. Circuits Syst. Video Technol., vol. 26, no. 1, pp. 117-129, January 2016.
[37] H. Guo, C. Zhu, Y. Liu, X. Yang and L. Luo, “Lagrange multiplier adaptation at CTU-level for VVC low-delay hierarchical coding,” in 2023 IEEE International Symposium on Broadband Multimedia Systems and Broadcasting (BMSB)., 2023, pp. 1-6.
[38] Y. Mao, M. Wang, Z. Ni, S. Wang and S. Kwong, “Neural network based rate control for versatile video coding,” IEEE Trans. Circuits Syst. Video Technol., vol. 33, no. 10, pp. 6072-685 October 2023.
[39] J. Boyce, E. Alshina, A. Abbas, “JVET common test conditions and evaluation procedures for 360° video,” in Joint Video Experts Team (JVET) of ITU-T SG 16 WP 3 and ISO/IEC JTC 1/SC 29/WG 11, Chengdu, CN, October 2016, pp. 1-6.
[40] Z. Wang, E. P. Simoncelli and A. C. Bovik, “Multiscale structural similarity for image quality assessment,” in The Thirty-Seventh Asilomar Conference on Signals, Systems and Computers, Pacific Grove, CA, USA, November 2003, pp. 1398-1402.
[41] R. Rassool, “VMAF reproducibility: validating a perceptual practical video quality metric,” in Proc. IEEE Int. Symp. Broadband Multimedia Syst. Broadcast. (BMSB), Cagliari, Italy, June 2017, pp. 1-2.

### SUMMARY OF INVENTION

Accordingly, in one aspect of the invention there is provided a rate control method for 360° videos coding. The method includes the steps of: a) converting a 360° video from a sphere domain to a plane domain to obtain two-dimensional (2D) plane video; b) extracting latitude information from the 2D plane video; c) adjusting strip-level allocated bits of the 2D plane video with the latitude information; each strip comprising Coding Tree Units (CTUs) in one row; d) identifying key CTU indices of each frame of the 2D plane video based on gaze points; and e) optimizing a CTU-level coding parameter based on the key CTU indices and a distortion dependency.

In some embodiments, Step b) further includes the steps of: f) extracting projection distortion information from conversion in Step a); and g) deriving the latitude information from the projection distortion information.

In some embodiments, Step a) is conducted during a Equi-rectangular projection (ERP) format process.

In some embodiments, the method further includes, before Step c), the step of: h) allocating strip-level bits according to spatial and temporal features of strips of frames of the 2D plane video.

In some embodiments, Step d) further includes the steps of: i) providing intra-frames of the 2D plane video to a scanpath prediction model; and j) obtain key CTUs of each said frame based on locations of the gaze points.

In some embodiments, in Step e) the CTU-level coding parameter is optimized based on a content complexity category and a distortion dependency factor.

In some embodiments, the distortion dependency factor is derived from the comparison between current CTUs and reconstructed CTUs.

In some embodiments, Step e) further comprises, for a given CTU, the steps of: k) reducing the CTU-level coding parameter if the given CTU is a key CTU; l) increasing the CTU-level coding parameter based on the distortion dependency factor if the given CTU is a non-key CTU.

In some embodiments, the CTU-level coding parameter includes a Lagrange multiplier.

In some embodiments, the CTU-level coding parameter includes Lagrange multipliers for intra-frames and inter-frames respectively.

According to another aspect of the invention, there is provided a non-transitory computer-readable medium, having stored thereon program instructions that, upon execution by a computing device, cause the computing device to perform the method described above or its variants.

According to a further aspect of the invention, there is provided a computing system which includes one or more processors; and memory containing instructions that, when executed by the one or more processors, cause the computing system to perform the method described above or its variants.

One can see that various embodiments of the1 invention therefore provide a rate control scheme for 360° VVC based on a human visual gaze mechanism, targeting at improving the coding performance and bitrate accuracy. In some embodiments, based on the Equi-rectangular Projection (ERP) format, latitude information is systematically analyzed and a stripe-level bit allocation scheme is established, to better mitigate the projection distortion. Subsequently, the Lagrange parameter 2 is further optimized with distortion dependency and identification of the visual gaze guided key Coding Tree Units (CTUs). In an experiment setup, a rate control scheme is implemented on the VVC Test Model for 360° video (VTM 19.0-360Lib 13.4). Experimental results show that the rate control scheme can achieve 2.64% and 2.82% BD-rate savings in terms of Weighted to Spherically uniform-Peak Signal-to-Noise Ratio (WS-PSNR) and Sphere-Peak Signal-to-Noise Ratio (S-PSNR) under the Low Delay P (LDP) configuration, respectively. Meanwhile, a healthier buffer status and better visual quality can be observed.

### BRIEF DESCRIPTION OF FIGURES

The foregoing and further features of the present invention will be apparent from the following description of embodiments which are provided by way of example only in connection with the accompanying figure(s), of which:

FIG. 1 illustrates the working flow of a rate control scheme according to a first embodiment of the invention.

FIG. 2 shows annulus mapping between sphere and plane domain for ERP format used in the scheme of FIG. 1.

FIG. 3 shows analyses of the circular truncated cone Q.

FIG. 4 illustrates acquisition of location information for key CTUs in the scheme of FIG. 1.

FIG. 5a shows R-D performance comparisons of “AerialCity” between the scheme in FIG. 1, default rate control scheme and fixed-QP encoded with LDP configurations in VTM19.0-360Lib13.4.

FIG. 5b shows R-D performance comparisons of “PoleVault” between the scheme in FIG. 1, default rate control scheme and fixed-QP encoded with LDP configurations in VTM19.0-360Lib13.4.

FIG. 5c shows R-D performance comparisons of “KiteFlite” between the scheme in FIG. 1, default rate control scheme and fixed-QP encoded with LDP configurations in VTM19.0-360Lib13.4.

FIG. 5d shows R-D performance comparisons of “Train” between the scheme in FIG. 1, default rate control scheme and fixed-QP encoded with LDP configurations in VTM19.0-360Lib13.4.

FIG. 6a shows comparisons of bit fluctuations of “DrivingInCity” between the scheme of FIG. 1 and default rate control scheme in VTM19.0-360Lib13.4.

FIG. 6b shows comparisons of bit fluctuations of “KiteFlite” between the scheme of FIG. 1 and default rate control scheme in VTM19.0-360Lib13.4.

FIG. 6c shows comparisons of buffer status of “DrivingInCity” between the scheme of FIG. 1 and default rate control scheme in VTM19.0-360Lib13.4.

FIG. 6d shows comparisons of buffer status of “KiteFlite” between the scheme of FIG. 1 and default rate control scheme in VTM19.0-360Lib13.4.

FIG. 7a shows the frames constructed by the default RC scheme (Bitrate: 2509.084 kbps, WS-PSNR: 34.2437 dB, S-PSNR: 34.2090 dB) for POC 281 of “DrivingInCity” coded with 2490.184 kbps under LDP configuration.

FIG. 7b shows the frames constructed by the proposed scheme (Bitrate: 2509.783 kbps, WS-PSNR: 35.1060 dB, S-PSNR: 35.0756 dB) for POC 281 of “DrivingInCity” coded with 2490.184 kbps under LDP configuration.

FIG. 8 shows a data processing system in some embodiments of the invention which may be used to execute the rate control scheme.

### DETAILED DESCRIPTION

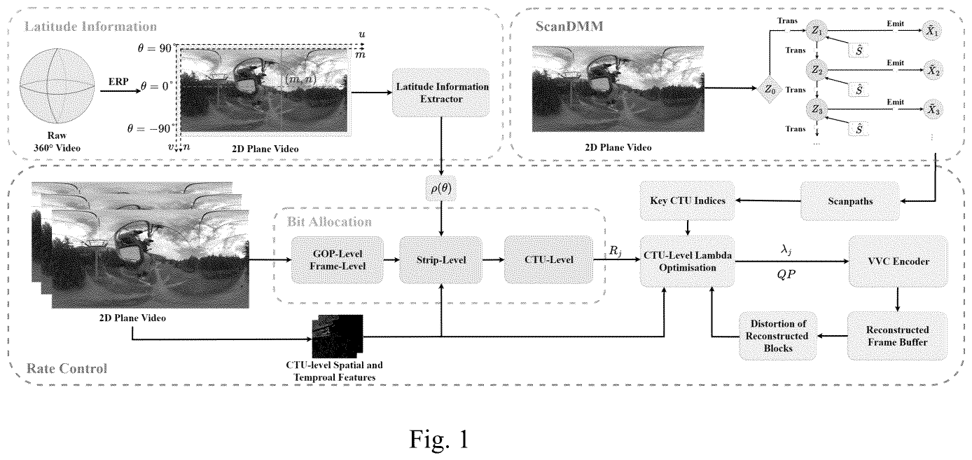

The rate control schemes for 360° videos coding according to various embodiments of the invention systematically analyze the characteristics of 360° video content and exploiting the human visual gaze mechanism. The working flow of the rate control scheme according to a first embodiment is shown in FIG. 1. The rate control scheme includes strip-level bit allocation and CTU-level coding parameter optimization. Specifically, strip-level bit allocation utilizes latitude information as a reliance. Key CTUs are determined, and a distortion dependency is proposed to optimize the CTU-level coding parameter. The main characteristics of the rate control scheme therefore include but are not limited to the followings:
There is provided a rate control scheme for 360° videos based on the human visual gaze mechanism, including strip-level bit allocation and CTU-level coding parameter optimization.
A strip-level bit allocation method is provided based on the latitude information by analyzing the ERP format from the sphere model to the 2D plane. Such a refined bit allocation strategy ensures that the allocation process is consistent with spatial gaze behavior.
By identifying the key CTU, a CTU-level @ optimization strategy is established based on distortion dependency to fully consider the temporal gaze behavior.

The 360° videos, which are typically featured with high data volume, desire highly efficient compression algorithms. He et al. presented the paradigm of 360° videos coding in [11]. Generally, the 360° video is mapped to a 2D plane through projection, and the 2D plane video is then fed into the codec. Conventionally, a series of projection methods are applied, such as the ERP format [14], pyramid projection format [15], cubemap projection format (CMP) [16], and octahedron projection format (OHP) [17]. These mapping algorithms transform 360° videos from spherical to 2D videos. The pyramid projection adaptively maps the spherical samples to six surfaces of the pyramid [18]. Analogously, CMP places the sphere model in a tangent cube and maps the spherical samples to the six surfaces of the pyramid. The OHP maps spherical samples onto an octahedron made up of four basic diamonds. These projection methods can slightly reduce projection distortion and remove the redundancy compared to ERP. However, irregular projections present challenges to block-based codecs. Therefore, the most common formats based on the current mainstream coding schemes are ERP and CMP.

2) Advanced Coding Technologies in VVC: VVC standard incorporates advanced technologies that surpass those of HEVC. To improve the compression efficiency for high-resolution videos, both the CTU and the maximum transform unit sizes have been increased. Innovative partitioning techniques, such as quad-tree, binary-tree, and ternary-tree structures, have been integrated into the Coding Unit (CU) partitioning scheme, enabling adaptation to complex video content [19]. Enhancements in intra-prediction and inter-prediction methods further reduce spatial and temporal redundancies by introducing additional prediction modes and allowing more flexible combinations of various prediction tools [20]-[22]. Additionally, trellis-coded quantization [23], which represents the mapping of transform coefficients and quantization candidates as a trellis graph, is employed. This method utilizes Viterbi searching to identify the optimal path with the lowest rate-distortion cost.

In principle, all mainstream coding schemes can be directly applied to 360° videos coding. Nevertheless, owing to the characteristics of its projection operation, it was imperative for encoder modules to be adjusted specifically for 360° videos coding. Intra prediction, inter prediction and in-loop filtering have been optimized for CMP format. When reference samples are outside of the frame border (layout boundary) or across the discontinuous edges in the projection layout, VVC alters them in the inter and intra prediction utilizing geometric surrounding samples [25]. Furthermore, to properly filter the layout of the cube map, Lin et al. suggested improving in-loop filtering techniques for 360° videos. The in-loop filter at the discontinuous edge is disabled, and samples located at geometric region are specifically processed based on the 360° video's geometric continuity attributes. For the ERP format, by modulating distortion based on sampling density, the non-uniform sampling property of 360° video projection schemes were exploited to improve compression efficiency [27].

Rate control aims at allocating coding bits for the best video quality within a limited bit budget. A λ-domain rate control model is employed in VTM, achieving satisfied trade-off between rate accuracy and computational complexity.

Considering the characteristics of 360° videos, the default rate control of a 2D video encoder is not optimal for 360° videos encoding. Hence, many rate control models have been modified to adapt to the 360° videos coding. In [30], by analyzing the process of projection, an entropy equilibrium optimization (EEO) was proposed to derive the optimal λ and enhance the coding performance of 360° videos for ERP and CMP formats. Li et al. proposed a bit allocation strategy based on weighting factors at the CTU-level, which is consistent with the ERP format [31]. In addition, a rate-distortion relationship based on the spherical model was studied to formulate the optimal λ by employing the Sphere-Peak Signal-to-Noise Ratio (S-PSNR) in [32]. In [33], a latitude-guided temporally dependent Rate-Distortion Optimization (RDO) for 360° videos was investigated, which incorporates temporal domain error propagation between frames into the rate control and adjusts the Quantization Parameter (QP) to achieve the desired optimization. Moreover, Zhao et al. [7] proposed an optimized rate control for 360° videos according to demand regions based on the saliency feature map. However, these models only investigate projection distortion or temporal domain error propagation, ignoring the human visual gaze mechanism in both spatial and temporal domains.

The scanpath prediction model, which aims to generate realistic gaze trajectories, has received increasing attention due to its significant impact on user gaze behavior in 360° scenes, as well as on the development of rendering, display, compression, and transmission. In the inventors' previous work [8], temporal dependence is considered as a significant factor in human gaze behavior and observed that human scanpaths in 360° scenes form complex, nonlinear, and dynamic attentional landscapes. These landscapes evolve over time through interactions between scene semantics and visual working memory. To model the visual states that encode this time-dependent attentional landscape, a probabilistic approach is presented. This method specifies the evolution of these states under the influence of scene semantics and visual working memory. This approach us initiated in the Deep Markov Model (DMM) [34], specifically referred to as Scan Deep Markov Model (ScanDMM). Specifically, by maintaining and updating visual states in a Markov chain, the mechanism of visual working memory is modelled. In addition, a transition function has been constructed and guided by semantics to learn the nonlinear dynamics of the states. This function models the impact of scene semantics on visual working memory.

As mentioned above, in one embodiment a rate control scheme for 360° videos based on the visual gaze mechanism, resulting in improved rate-distortion performance. The visual gaze mechanism includes spatial gaze behavior and temporal gaze behavior, which underpins the proposed bit allocation and optimization of the coding parameter.

Initially, human eye gaze habits are analyzed within a spherical model and consider the projection distortion characteristics of the ERP format are considered to extract latitude information from each individual sample. Incorporating this latitude information and content complexity, the strip-level bit allocation thoroughly accounts for spatial gaze behavior. Following this, a CTU-level λ optimization strategy is developed to derive an improved Lagrange multiplier ω for subsequent encoding. This λ optimization strategy incorporates content complexity, key CTU indices, and distortion dependency, enabling it to adeptly capture temporal gaze behavior. The following sections provide a detailed description of the proposed strip-level bit allocation and optimization of the coding parameter λ. The overall workflow is illustrated in FIG. 1.

Next, the latitude information acquisition will be described in detail. During the ERP process, stretching and distortion are more prominent with increasing latitude. Meanwhile, it has been observed that human eyes tend to concentrate on regions close to the equator in spatial gaze behavior. This finding aligns with the characteristics of the ERP format. Given this alignment, obtaining latitude information is an effective way to capture the characteristics of spatial gaze behavior. To facilitate the calculation process, pixel projection distortion information (n) is represented as the area ratio before and after the ERP transformation. Thus, the projection distortion information is extracted and used as latitude information to guide the subsequent bit allocation at strip-level, which better reflects the spatial gaze behavior.

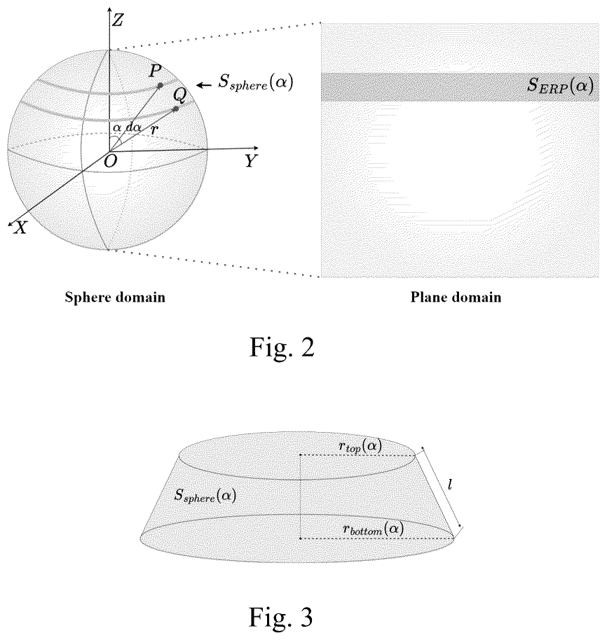

As shown in FIG. 2, in a 3D spherical coordinate system, the center and radius of the sphere are denoted as O and r, respectively. Given a point P, OP has an angle α with the Z-axis. Q exists at different latitudes of the same longitude. OP has an angle with OQ of da. To obtain a latitude slice of the sphere, sections are made parallel to the XOY plane along the latitudes of points P and Q. If dα is sufficiently small, the latitude slice approximates a circular truncated cone Ω, as shown in FIG. 3. As such, ERP format can be regarded as the process of mapping the curved sides of Ω onto a rectangle. In this way, the task of obtaining the projection distortion is converted as exploring the relationship between the area of the side of circular truncated cone Sₛₚₕₑᵣₑ(α) and area of rectangle S_{ERP}(α) at α. To calculate the side area of Ω, the radius of the top and bottom circles rₜₒₚ(a) and r_{bottom}(α) should be obtained, which can be derived as follows,

$${r}_{top} ( α ) = r \cdot sin α , \qquad ( 1 )$$

$${r}_{bottom} ( α ) = r \cdot sin ( α + d α ) .$$

Assuming that the busbar of Ω is l and the Sₛₚₕₑᵣₑ(α) can be calculated as follows,

$$\begin{matrix}{S}_{sphere} ( α ) = π \cdot [ {r}_{top} ( α ) + {r}_{bottom} ( α ) ] \cdot l \\ = π r \cdot [ sin α + sin ( α + d α ) ] \cdot l\end{matrix} . \qquad ( 2 )$$

l is also represented by the height of the rectangle in the plane domain, and the width is the equator's length. Correspondingly, S_{ERP}(α) is computed according to the l as follows,

$${S}_{ERP} ( α ) = 2 π r \cdot l . \qquad ( 3 )$$

Similar to [30], the ratio between the two areas is calculated. Thus, the projection distortion information η at α can be obtained as follows,

$$\begin{matrix}η ( α ) = \frac{{S}_{sphere} ( α )}{{S}_{ERP} ( α )} = sin ( α + \frac{d α}{2} ) \cdot cos \frac{d α}{2} \\ \approx sin α\end{matrix} . \qquad ( 4 )$$

With dα closing to 0, the ratio can be approximately equal to sin α. As such, a strict sinusoidal relationship exists between the side area in the sphere domain and the rectangular area in the plane domain. Specifically, the ratio increases with α in the range [0, π/2], and Sₛₚₕₑᵣₑ gradually converges to S_{ERP}. At the equator (α=π/2), Sₛₚₕₑᵣₑ is equal to SERP.

Once the projection distortion information for the ERP format is determined, the latitude information corresponding to each sample can be derived. In 360° video coding platform, 360Lib [10] specifies the ERP format workflow and related parameters. In particular, θ in the range [−π/2, π/2] is defined as the latitude parameter. The relationship between θ and α is as follows,

$$θ = π / 2 - α . \qquad ( 5 )$$

As such, one can further obtain,

$$ρ ( θ ) = cos θ , \qquad ( 6 )$$

where ρ(·) is defined as a function that obtains latitude information about θ. 360-Lib [10] provides the uv plane, which contains a grid of video-sampled pixels in the 2D plane, as illustrated in FIG. 1. Referring the sampling pixel position as (m, n), where m and n are the horizontal and vertical coordinates of the sampling pixel. Thus, if the position information (m, n) of the sample is available, it can be transformed into the uv plane via,

$$u = ( m + 0.5 ) / W , 0 \leq m < W , \qquad ( 7 )$$

$$v = ( n + 0.5 ) / H , 0 \leq n < H ,$$

where u and v are the relevant parameters of uv plane, and W and H are the width and height of 2D plane video, respectively.

To obtain θ, the parameter v is mapped in the uv plane again into the sphere model. The mapping of v to θ is formulated as

$$θ = ( 0.5 - v ) \cdot π . \qquad ( 8 )$$

Therefore, after obtaining the sample positions in 2D, the ρ(θ) can be determined. ρ(θ) is defined as the latitude information that indicates the projection distortion before and after the ERP format and serves as the basis for the strip-level bit allocation scheme.

Next, the strip-level bit allocation will be discussed in detail. Given that the aforementioned latitude information is primarily represented by each row of pixels in a 360° video frame, the bit allocation at Group of Picture (GOP)-level and frame-level can continue to follow the default method adopted in VVC. Here all CTUs located in the same row are defined as a “strip”. Subsequently, a strip-level bit allocation strategy is provided which is designed to better accommodate the spatial gaze behavior and the content characteristics of 360° video sequences. Finally, CTU-level bit allocation is performed based on the remaining bits available within each strip.

The content complexities, in terms of content features that include spatial features and temporal features [29], are analyzed on-the-fly, which act as informative clues for bit allocation. Thus, the strip-level bits are allocated according to the content feature [29] and then adjusted for the latitude information.

Given the bits allocated in the current frame, the number of bits remaining R_{rf} can be obtained during the coding process. The pre-allocated bits for the i-th strip R_{Pre}(s) are calculated according to the corresponding strip content feature F_{Strip}(s) as follows,

$${R}_{Pre} ( s ) = {R}_{rf} \cdot \frac{{F}_{strip} ( s )}{{\sum }_{s = w + 1}^{{N}_{s}} {F}_{strip} ( s )} , \qquad ( 9 )$$

where Nₛ and ω indicate the number of strips and coded strips contained in the current frame.

Subsequently, the strip-level allocated bits are adjusted with latitude information,

$$R ( s ) = {R}_{Pre} ( s ) \cdot \frac{L I ( s )}{L {I}_{tavg}} , \qquad ( 10 )$$

where R(s) is the bits of s-th strip. LI(s) and LI_{avg} are the latitude information of the strip and the average latitude information, respectively. The LI(s) can be given by

$$L I ( s ) = {\sum }_{i = 1}^{{N}_{CTU}} \frac{{\sum }_{p = 1}^{{N}_{p}} {ρ}_{i} ( {θ}_{p} )}{{N}_{p}} . \qquad ( 11 )$$

Herein, N_{CTU} is the number of CTUs in a strip. ρᵢ(θₚ) represents the latitude information of the p-th pixel in the i-th CTU, and Nₚ is the corresponding number of pixels.

Once the bit allocation for each strip has been completed, the target bit allocation for the i-th CTU within the current strip can be derived based on the remaining bits available in that strip, denoted as Rᵣₛ, as follows,

$${R}_{CTU} ( i ) = {R}_{r s} \cdot \frac{{ω}_{f} ( i )}{{\sum }_{j = i}^{{N}_{CTU}} {ω}_{f} ( j )} , \qquad ( 12 )$$

where R_{CTU}(i) represents the bits allocated to the i-th CTU. ω_{f} denotes the weight factor, which reflects the attributes of the content. Subsequently, one can obtain the Lagrange multiplier λ* by,

$$λ *= β \cdot {R}_{CTU}^{γ} , \qquad ( 13 )$$

where R_{CTU} represents the bits allocated to the current CTU, β and γ are model parameters derived from the VVC default rate control scheme, which are dynamically updated during the encoding process according to the parameters update algorithm. It is also worth noting that λₛ and λₜ represent the Lagrange multipliers for intra-frames and inter-frames, respectively.

Additionally, the strip-level content features utilized in the above-mentioned are derived as follows. Specifically, content features are typically categorized into two primary types: spatial features and temporal features. The former pertains to intra-frames, whereas the latter relates to inter-frames. To be more specific, for an intra-frame, the spatial feature of the s-th strip SFₛₜᵣᵢₚ(s) can be obtained by ACO [29]. Analogously, the temporal feature of the s-th strip TFₛₜᵣᵢₚ(s) is calculated as follows,

$$T {F}_{strip} ( s ) = {\sum }_{i = 1}^{{N}_{CTU}} [ {μ}_{M} \cdot M V I ( i ) + {μ}_{S} \cdot S {F}_{D} ( i ) ] , \qquad ( 14 )$$

where μ_{M} and μ_{S} are coefficients. MVI is the motion vector (MV) information, defined as,

$$M V I = \sqrt{{( M {V}_{x} )}^{2} + {( M {V}_{y} )}^{2}} , \qquad ( 15 )$$

where MVₓ and MV_{y} represent the horizontal and vertical components of the motion vector at the reference pixel, respectively. SFD denotes the absolute value of the spatial feature difference between the current and its corresponding reference CTUs. Fₛₜᵣᵢₚ(s) are replaced by SFₛₜᵣᵢₚ(s) and TFₛₜᵣᵢₚ(s) in intra- and inter-frames, respectively, and are involved in the strip-level and CTU-level bit allocation process described by Eqns. (9)-(13).

Next, the CTU-level coding parameter optimization is described in detail. Building upon the presentation of Lagrange multipliers at the CTU-level, the coding parameter λ is further optimized. This refinement takes into account content complexities, key CTU indices, and distortion dependency to enhance R-D performance and pursue more accurate rate control.

Specifically, an optimized strategy for 2 is conducted at the CTU-level. The λⱼ of the j-th CTU is optimized based on the content complexity categories, key CTU indices, and the distortion dependency factor φ as follows,

$${λ}_{j} = K {φ}_{j} \cdot λ * + ( 1 - K ) ( 1 - C \text{*)} \cdot \frac{λ *}{{φ}_{j}} + ( 1 - K ) C * \cdot λ * , \qquad ( 16 )$$

where λ* represents λₜ or λₛ, depending on the type of frame. C* denotes Cₜ or Cₛ, which indicates the complexity category flag of the current CTU. K is determined based on the identification of key CTU. If the CTU is a key CTU, K equals 1. If the CTU is not indicated as a key CTU, K is set to 0. φⱼ represents the distortion dependency factor of j-th CTU, which can be derived in the way as explained below.

A detailed analysis of Eqn. (16) reveals that when the current CTU is classified as a key CTU, λ is reduced according to the distortion dependency factor φ. Conversely, when the current CTU is classified as a non-key CTU and its content complexity falls below the frame average (that is, C*=0), λ increase based on φ. In all other cases, λ remains unchanged.

Subsequently, the λⱼ will be mapped to the QPⱼ for encoding the CTU [9]. It is worth mentioning that in order to ensure smoothed quality of CTUs, the difference between the QPs mapped with and without 2 optimization is limited to a range of [−2, 2].

1) Content Complexity Categories: In particular, the spatial feature SF_{CTU} (j) and the temporal feature TF_{CTU} (j) of the j-th CTU are calculated with the adaptive Canny operation [29]. The frame-level content complexity of one frame can be represented as follows,

$${κ}_{s} = \frac{1}{N} {\sum }_{j = 1}^{N} S {F}_{CTU} ( j ) , \qquad ( 17 )$$

$${κ}_{t} = \frac{1}{N} {\sum }_{j = 1}^{N} T {F}_{CTU} ( j ) ,$$

where Kₛ and Kₜ are the spatial and temporal content complexity in the intra and inter-frame, respectively. N denotes the number of CTUs included in a frame. As such, for an intra-coded frame, CTUs are classified to two categories as follows,

$${C}_{s} = \{ \begin{matrix}1 , & S {F}_{curCTU} > {κ}_{s} \\ 0 , & S {F}_{curCTU} \leq {κ}_{s}\end{matrix} , \qquad ( 18 )$$

where SF_{curCTU} is the spatial feature of current CTU. Meanwhile, given the temporal feature of the current CTU TF_{curCTU} in the inter-frame, the classification is performed by comparing the temporal feature of individual CTU with the averaged frame-level temporal content complexity,

$${C}_{t} = \{ \begin{matrix}1 , & T {F}_{curCTU} > {κ}_{t} \\ 0 , & T {F}_{curCTU} \leq {κ}_{t}\end{matrix} . \qquad ( 19 )$$

So far, the content complexity flags have been derived for CTUs in both intra and inter-frames, based on spatial and temporal features, respectively.

2) Key CTUs Identification Based on ScanDMM: As the state-of-the-art scanpath prediction model, ScanDMM [8] builds a semantics-guided transition function to learn the non-linear dynamics of a time-dependent attentional landscape. Each frame in the 360° video has a strong temporal correlation, which essentially matches the time-dependent attention landscape in ScanDMM. In the inventors' previous work [8], the ScanDMM model generalization capability has been verified on the saliency detection task. Therefore, the time-dependent characteristics of ScanDMM are exploited as a saliency detection model for 360° videos and obtain the key CTUs of each frame based on the location of gaze points, taking full consideration of the observer's dynamic temporal gaze behavior. This provides instructive primitives for encoding 360° videos.

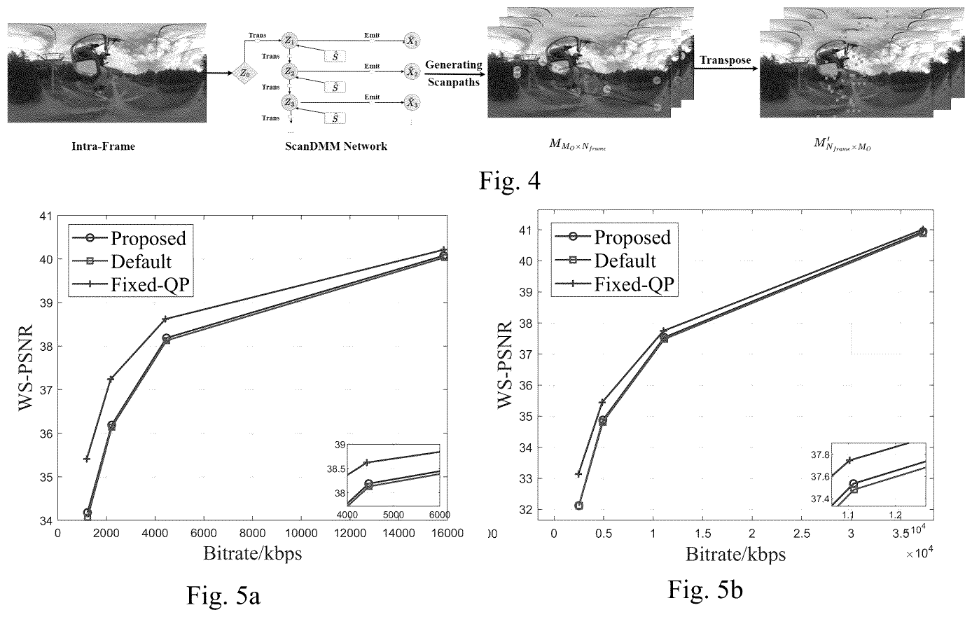

As illustrated in FIG. 4, the input of the ScanDMM network is the intra-frame, which is the first frame of a GOP. Each GOP contains N_{frame} frames. ScanDMM can generate the predicted path \tilde{X}_{1:N}_{_{frame}} by using the visual states Z_{1:N}_{_{frame}}, which are obtained by the history temporal state and scene semantic ŝ of the intra-frame. Then, M_{O} scanpaths are aggregated with N_{frame} gaze points on each path, which can be defined by an observation matrix M of size M_{O}×N_{frame}. Herein, M_{O} scanpaths correspond to M_{O} observers [29]. M is transposed as M′ with the size of N_{frame}×M_{O}. The rows of M′ represent the observer's gaze points in each frame, and the columns reflect the paths gazed by the same observer in the N_{frame} frames. The CTUs, in which gaze points are located, are marked as the key CTUs, and the CTU indices also be acquired. Otherwise, CTUs are made as the non-key CTUs.

3) Derivation of Distortion Dependency Factor: In this subsection, the aim is to derive the distortion dependency factor φⱼ for the j-th CTU. Generally speaking, temporal and spatial neighboring CTUs are utilized in inter and intra-prediction for the current CTU. The distortions within the former coded CTU will propagate to the subsequent coding units along the propagation chain, resulting in a degradation of video quality [35]-[37]. To mitigate the effect of propagated distortion of coded blocks on the current CTU, a CTU-level λ optimization strategy is established by considering the distortion dependency.

Given the target bits Rf for the current 360° video frame, the actual bits should be limited within the budget with minimum distortions. Unlike conventional 2D video, latitude information must be incorporated into the rate-distortion problem for 360° video. Therefore, this process can be formulated as a constrained problem at the frame-level, expressed as follows:

$$min {\sum }_{i = 1}^{N} {ρ}_{i} {D}_{i} , s . t . {\sum }_{i = 1}^{N} {R}_{i} \leq {R}_{f} , \qquad ( 20 )$$

where Rᵢ and Dᵢ are bitrate and distortion of the i-th CTU, respectively. Herein, D is calculated by the mean square error between the raw and reconstructed videos. The current frame contains N CTUs. The latitude information of i-th CTU ρᵢ can be derived from Eqn. (11) as follows,

$${ρ}_{i} = \frac{1}{{N}_{p}} {\sum }_{p = 1}^{{N}_{p}} ρ ( {θ}_{p} ) . \qquad ( 21 )$$

The Lagrange multiplier ζ at frame-level is applied to convert the conditional problem into an unconditional one,

$${J}_{f} = {\sum }_{i = 1}^{N} {ρ}_{i} {D}_{i} + ζ \cdot {\sum }_{i = 1}^{N} {R}_{i} , \qquad ( 22 )$$

where J_{f} is the R-D cost of one frame. During the coding of the j-th CTU, to achieve the minimum R-D cost J_{f}, the partial derivation of Rⱼ on J_{f} should be equal to zero. This can be expressed as,

$$\frac{\partial {J}_{f}}{\partial {R}_{j}} = \frac{\partial ( {\sum }_{i = 1}^{N} {ρ}_{i} {D}_{i} + ζ \cdot {\sum }_{i = 1}^{N} {R}_{i} )}{\partial {R}_{j}} = 0 , j = 1 , 2 , … , N . \qquad ( 23 )$$

Herein, we assume that CTUs within a frame are independent of each other,

$$\frac{\partial ( {\sum }_{i = 1}^{N} {R}_{i} )}{\partial {R}_{j}} = 1. \qquad ( 24 )$$

Hence, combining Eqn. (23) and Eqn. (24), one can obtain,

$$\frac{\partial ( {\sum }_{i = 1}^{N} {ρ}_{i} {D}_{i} )}{\partial {R}_{j}} = - ζ . \qquad ( 25 )$$

To establish the distortion relationship between the current CTU and the restructured CTU, ∂Rⱼ/∂D_{f} is multiplied to both sides of Eqn. (25),

$$\frac{\partial ( {\sum }_{i = 1}^{N} {ρ}_{i} {D}_{i} )}{\partial {D}_{j}} = - ζ \cdot \frac{\partial {R}_{j}}{\partial {D}_{j}} = ζ \cdot \frac{{ρ}_{j}}{{ζ}_{j}} . \qquad ( 26 )$$

For the CTU in intra-frame, spatial dependencies generally exist in the neighboring above and left reconstructed CTUs. Therefore, the distortions of the above and left reconstructed CTUs are employed for analyzing the distortions of the current CTU. One can obtain,

$$\frac{\partial ( {ρ}_{j - 1} {D}_{a} + {ρ}_{j} {D}_{l} + {ρ}_{j} {D}_{j} )}{\partial {D}_{j}} = ζ \cdot \frac{{ρ}_{j}}{{ζ}_{j}} , \qquad ( 27 )$$

where D_{α} and Dₗ are the distortions of the above and left CTUs, respectively. ρⱼ₋₁ is the latitude information of the above CTU. Since the left CTU is located within the same strip as the current CTU, the associated latitude is identical.

In this disclosure, the dependency relationship of the above and left CTUs on the current CTU are defined as

$${π}_{j}^{a} and {π}_{j}^{l}$$

respectively. The dependency relationship is applied to approximate the distortion bias of the reconstructed CTU to the current CTU. Specifically, Mean Squared Error (MSE) is utilized to calculate the distortion of the restructured blocks and normalize the distortion within the range to [0,1]. Additionally, correlation coefficients

$${R}_{a}^{2} and {R}_{l}^{2}$$

for the current CTU, and the above and left CTU, and the above and left CTU are calculated [38]. The

$${π}_{j}^{a} and {π}_{j}^{l}$$

are given as follows,

$${π}_{j}^{a} = f \cdot {D}_{a} \cdot {ℛ}_{a}^{2} , \qquad ( 28 )$$

$${π}_{j}^{l} = f \cdot {D}_{l} \cdot {ℛ}_{l}^{2} ,$$

where f is a constant. Eqn. (27) can be rewritten as follows

$${ρ}_{j - 1} \cdot {π}_{j}^{a} + {ρ}_{j} + {ρ}_{j} \cdot {π}_{j}^{l} = ζ \cdot \frac{{ρ}_{j}}{{ζ}_{j}} . \qquad ( 29 )$$

Since the resolution of 360° video is usually larger than 4K or even 8K, the variation of the latitude information between adjacent strips can be negligible. To simplify the equation, set ρⱼ₋₁≈ρⱼ for simplicity. In this manner, the distortion dependency factor for the j-th CTU φⱼ is defined as follows,

$${φ}_{j} = \frac{1}{1 + f \cdot {D}_{a} \cdot {ℛ}_{a}^{2} + f \cdot {D}_{l} \cdot {ℛ}_{l}^{2}} . \qquad ( 30 )$$

For an inter-coded frame, the correlation between the temporal collocated blocks and the current coding block is high. The spatial distortion dependency is extended to the temporal domain by treating the reference CTUs in the first two frames of reference frame list as temporal adjacent restructured blocks for P-frames. Likewise, in the case of B-frames, the first frame from both the forward and backward reference lists will be extracted to serve as the temporal adjacent restructured frames, respectively. The dependency factors of the first and second reference CTUs on the current CTU with

$${π}_{j}^{r 1} and {π}_{j}^{r 2}$$

can be calculated with Eqn. (28). Thus, for the inter-frame, φⱼ can be obtained in a similar way. Then, for the inter-frame, φⱼ can be obtained in a similar way. Then, φⱼ can be introduced to Eqn. (16) to optimize the λⱼ.

To verify the effectiveness of the method according to the exemplary embodiment as mentioned above, the method is incorporated into the VTM-19.0-360Lib 13.4 [9], [10]. The Low Delay P (LDP) configuration is employed following the Common Test Conditions (CTCs) [39]. In particular, the GOP sizes for low delay and random access configurations are set as 16 and 32 for both the default rate control of VTM-19.0-360Lib 13.4 and the rate control method. Also, the number of observers M_{O} in ScanDMM is configured to be 49 as in [8]. The target bitrates are obtained with fixed-QP coding for each sequence, where the QPs are set to 22, 27, 32, and 37, respectively.

The quality evaluation measures adopted for 360° video codec processes are Sphere-Peak Signal-to-Noise Ratio (S-PSNR) [12], Weighted to Spherically Uniform-Peak Signal-to-Noise Ratio (WS-PSNR) [13].

To measure the accuracy of the rate control scheme, ΔBR is chosen to represent the difference between the actual bitrate and the target bitrate, which is calculated as follows,

$$Δ BR = \vert \frac{{R}_{act} - {R}_{tar}}{{R}_{tar}} \vert \times 100 \% , \qquad ( 31 )$$

where R_{act} and Rₜₐᵣ are the actual and target bitrate, respectively. Better rate control scheme is expected to achieve an output bitrate close to the target bitrate, indicating that the smaller the ΔBR, the more accurate the rate control.

Meanwhile, buffer status is one of the measures for evaluating the performance of rate control. As a bridge between the encoder and actual transmission, buffer overflow and underflow issues are crucial for video transmission. Therefore, in order to observe the variation of buffer status for rate control schemes, a virtual buffer is constructed to measure the status, which is defined as

$$B F = \{ \begin{matrix}{N}_{f} \cdot \frac{{R}_{T}}{FR} - {\sum }_{i = 0}^{{N}_{f} - {N}_{0}} {R}_{i} , & if {N}_{f} \geq {N}_{0} \\ {N}_{f} \cdot \frac{{R}_{T}}{FR} & otherwise\end{matrix} , \qquad ( 32 )$$

where N_{f} is the number of encoded frames and No is the decoding delay in terms of the frame number. BF is the sequence-level buffer status at the frame N_{f}. Rᵢ and R_{T} are the actual coding bits of i-th frame and the target bitrate of the encode sequence. Also, FR represents the frame rate corresponding to the video.

In addition, to evaluate the encoding complexity of rate control, we measure the time complexity with T_{enc}, which is defined as

$$Δ {T}_{enc} = \frac{{T}_{pro} - {T}_{anc}}{{T}_{anc}} \times 1 \; 00 \% . \qquad ( 33 )$$

Herein, Tₚᵣₒ is total encoding time when the method used in encoding, and T_{anc} is the encoding time of the anchor encoder.

BD-rate is utilized to evaluate the coding performance of the rate control scheme, and WS-PSNR and S-PSNR are applied as the distortion measures to calculate the BD-rate. In addition, in order to ascertain the suitability of the model for human eye perception, BD-rate based on Structural Similarity Index (SSIM), Muti-Scale Structural Similarity Index (MS-SSIM) [40], and Video Multimethod Assessment Fusion (VMAF) [41] are also employed as evaluation measures.

In this disclosure, the VTM-19.0-360Lib13.4 default rate control scheme is designated as the default scheme. Table I demonstrates the performance of the default and the proposed rate control scheme on VTM19.0-360Lib13.4. In comparison with the Fixed-QP compression, the proposed rate control is capable of saving more BD-rate than the default scheme. Specifically, the proposed scheme can achieve BD-rate savings of 2.64% and 2.82% based on WS-PSNR and S-PSNR compared to the VVC default scheme encoding. Meanwhile, the bitrate error ΔBR is lower for the proposed scheme. As such, the proposed scheme outperforms the default scheme in terms of R-D performance while ensuring that the actual bitrate is closer to the target bitrate. This is owning to the proper utilization of the ERP format characteristics and sample-level latitude information analyses, leading to the improvement of R-D performance. To further demonstrate the superiority of the proposed scheme, we also implement Zhao et al.'s scheme [7] on VTM19.0-360Lib13.4. In table I, one can find that the proposed scheme outperforms Zhao et al.'s scheme [7] with 0.93% and 1.31% BD-rate savings according to WS-PSNR and S-PSNR. To further demonstrate the effectiveness of the proposed scheme in various coding scenarios, LDB and RA configurations are also incorporated into the experiment process in this paper with first 100 frames of all sequences. The experimental results, presented in Table II, indicate that the proposed algorithm outperforms the default in terms of both bitrate error and BD-rate.

TABLE I
PERFORMANCE OF PROPOSED RATE CONTROL SCHEME AND ZHAO
et al.'s SCHEME COMPARED WITH DEFAULT SCHEME COMPRESSION
ON VTM19.0-360LIB13.4 UNDER LDP CONFIGURATION

| | | BD-Rate/% | | | | | | |
|---|---|---|---|---|---|---|---|---|
| | | (Zhao et al.'s | | BD-Rate/% | | | | |
| | | Scheme [7]) | | (Proposed Scheme) | | ΔBR/% | | |
| Resolution | Sequence | WS-PSNR | S-PSNR | WS-PSNR | S-PSNR | Default | Zhao et al.'s | Proposed |
| 4K | AerialCity | −2.06 | −1.16 | −2.58 | −2.90 | 1.64 | 1.59 | 1.40 |
| | DrivingInCity | −0.32 | −0.10 | −1.37 | −1.68 | 0.89 | 1.24 | 0.81 |
| | DrivingInCountry | −2.08 | −1.98 | −1.26 | −1.28 | 0.75 | 0.82 | 0.71 |
| | PoleVault | −0.86 | −0.40 | −1.62 | −2.01 | 1.17 | 0.64 | 0.98 |
| 8K | Harbor | −2.84 | −2.68 | −4.15 | −4.51 | 1.91 | 1.20 | 1.56 |
| | KiteFlite | −1.05 | −0.97 | −1.83 | −1.83 | 1.11 | 1.04 | 1.03 |
| | SkateboardTrick | −0.86 | −0.94 | −1.03 | −1.15 | 0.48 | 0.39 | 0.36 |
| | Train | −0.96 | −1.83 | −1.30 | −1.15 | 0.99 | 0.94 | 0.91 |
| | ChairliftRide | −1.34 | −1.42 | −2.91 | −3.27 | 0.65 | 0.71 | 0.53 |
| | SkateboardInLot | −4.75 | −3.84 | −8.52 | −8.41 | 0.09 | 0.04 | 0.03 |

| | | | | | | | |
|---|---|---|---|---|---|---|---|
| Average | −1.71 | −1.51 | −2.64 | −2.82 | 0.97 | 0.86 | 0.83 |

TABLE II
PERFORMANCE OF PROPOSED RATE CONTROL SCHEME COMPARED WITH DEFAULT
SCHEME ON VTM19.0-360LIB13.4 UNDER LDB AND RA CONFIGURATIONS

| | | LDB | | | | RA | | | |
|---|---|---|---|---|---|---|---|---|---|
| | | BD-Rate/% | | | | BD-Rate/% | | | |
| | | (Anchor: Default) | | ΔBR/% | | (Anchor: Default) | | ΔBR/% | |
| Resolution | Sequence | WS-PSNR | S-PSNR | Default | Proposed | WS-PSNR | S-PSNR | Default | Proposed |
| 4K | AerialCity | −1.98 | −1.97 | 5.24 | 4.91 | −1.61 | −1.77 | 12.63 | 10.85 |
| | DrivingInCity | −7.76 | −7.73 | 3.30 | 3.16 | −1.21 | −1.30 | 8.93 | 8.74 |
| | DrivingInCountry | −2.89 | −2.74 | 3.90 | 3.88 | −3.64 | −3.65 | 9.04 | 8.33 |
| | PoleVault | −2.46 | −3.01 | 4.86 | 4.81 | −2.17 | −2.16 | 9.51 | 8.74 |
| 8K | Harbor | −3.31 | −3.29 | 4.43 | 4.55 | −0.46 | −0.45 | 12.09 | 11.23 |
| | KiteFlite | −0.68 | −0.72 | 4.38 | 4.07 | −0.32 | −0.42 | 9.24 | 8.26 |
| | SkateboardTrick | 2.05 | 1.91 | 3.45 | 3.07 | 0.78 | 0.56 | 7.91 | 6.73 |
| | Train | −9.45 | −9.52 | 3.93 | 4.78 | 1.25 | 1.34 | 12.14 | 6.20 |
| | ChairliftRide | −5.68 | −5.74 | 3.05 | 2.91 | 1.47 | 1.47 | 9.52 | 6.61 |
| | SkateboardInLot | −9.99 | −10.10 | 1.96 | 2.02 | −4.91 | −4.93 | 5.95 | 5.63 |

| | | | | | | | | |
|---|---|---|---|---|---|---|---|---|
| Average | −4.22 | −4.29 | 3.85 | 3.81 | −1.08 | −1.13 | 9.70 | 8.13 |

Furthermore, Table III also provides the performance of the proposed rate control scheme compared with the default scheme in terms of human visual perception. In particular, the proposed scheme can save 3.96% and 3.42% BD-rate compared to the default scheme while maintaining the same SSIM and MS-SSIM, respectively. In addition, the proposed scheme demonstrates superior performance in terms of VMAF compared to the default one. This benefits from incorporating the human visual gaze mechanism into rate control, resulting in more effective expression of spatial and temporal gaze behaviors and closer alignment with human vision perception.

TABLE III
VISUAL PERCEPTION OF PROPOSED RATE CONTROL
SCHEME COMPARED WITH DEFAULT SCHEME ON VTM19.0-
360LIB13.4 UNDER LDP CONFIGURATION

| | | BD-Rate/% | | |
|---|---|---|---|---|
| | | (Anchor: Default Scheme) | | |
| Resolution | Sequence | SSIM | MS-SSIM | VMAF |
| 4K | AerialCity | −13.84 | −9.11 | −5.33 |
| | DrivingInCity | −9.86 | −6.08 | −3.84 |
| | DrivingInCountry | −1.60 | −0.99 | −0.71 |
| | PoleVault | −4.17 | −6.96 | −2.98 |
| 8K | Harbor | −4.72 | −3.50 | −4.36 |
| | KiteFlite | −2.47 | −1.78 | −4.56 |
| | SkateboardTrick | −0.26 | −0.36 | −0.76 |
| | Train | −0.47 | −0.34 | −0.99 |
| | ChairliftRide | −0.38 | −3.10 | −4.01 |
| | SkateboardInLot | −1.87 | −1.97 | −3.16 |

| | | | |
|---|---|---|---|
| Average | −3.96 | −3.42 | −3.07 |

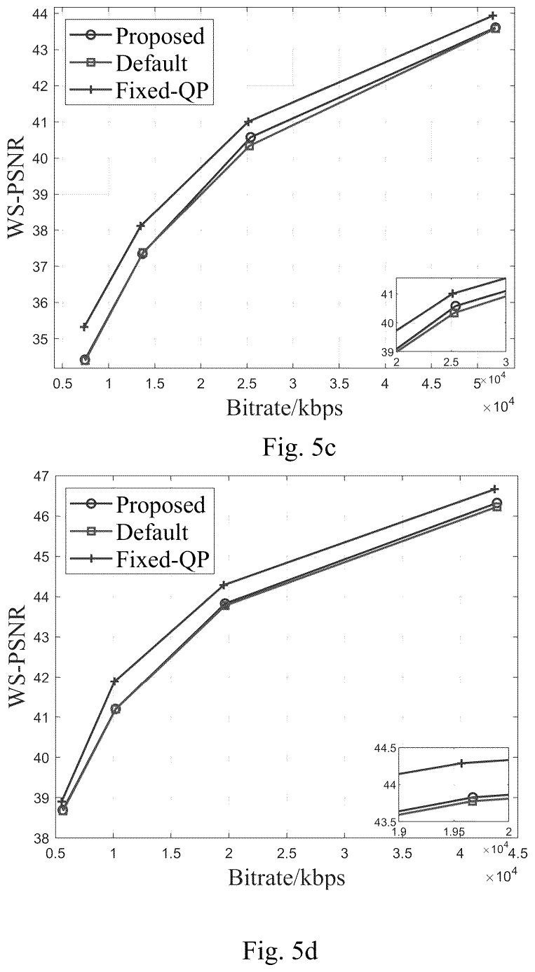

FIG. 5 illustrates the R-D performance of the proposed rate control scheme, default rate control scheme, and the fixed-QP compression. The R-D performance of the proposed scheme exceeds the default scheme and is closer to the curve of the fixed-QP configuration. This indicates that the proposed scheme provides superior WS-PSNR at the same bitrate with better rate distortion performance.

Table I shows that the ΔBR of the proposed scheme is smaller than that of the default scheme and advanced schemes. To be more specific, the ΔBR of the proposed scheme is 0.83%, which is lower than the default scheme's 0.97% and Zhao et al.'s scheme at 0.86%, indicating that the proposed scheme could achieve more accurate rate control. In addition, the proposed algorithm performs well in ΔBR under RA and LDB con-figurations as shown in Table II. The proposed strip-level bit allocation and key CTU identification are capable of providing more flexible and accurate bit allocation, resulting in improved control accuracy.

Moreover, the time complexity, measured as ΔT_{enc} is 6.24% under the LDP configuration. Similarly, under the LDB and RA configurations, ΔT_{enc} are 7.14% and 6.84%, respectively. Considering the aforementioned performance metrics collectively, the proposed scheme achieves improved coding efficiency for 360° video while introducing only a marginal increase in time complexity.

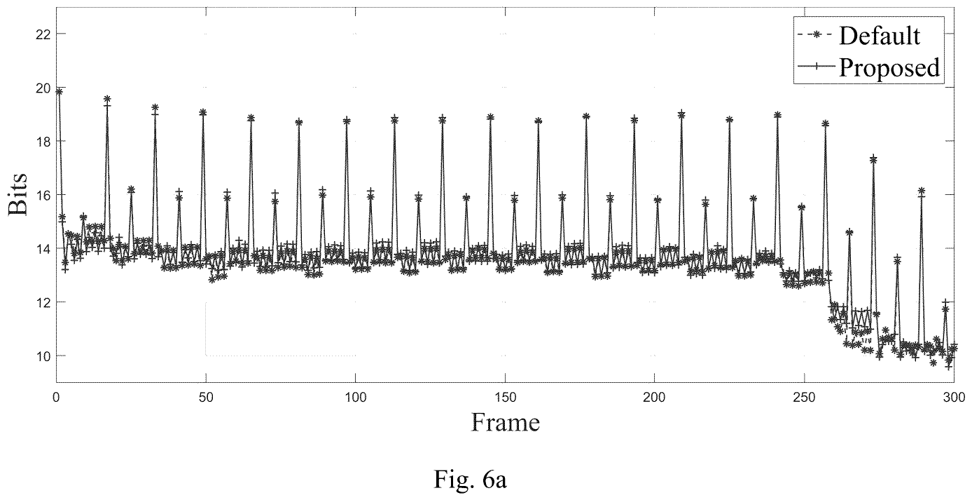

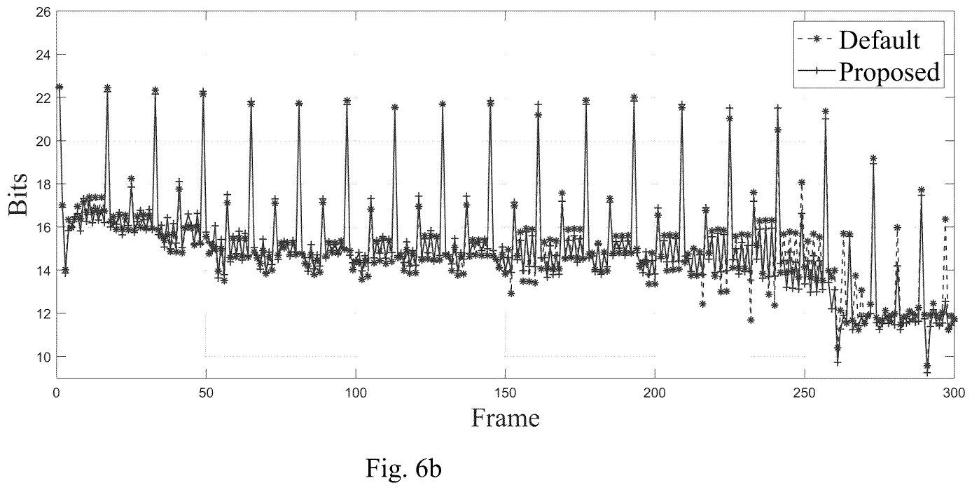

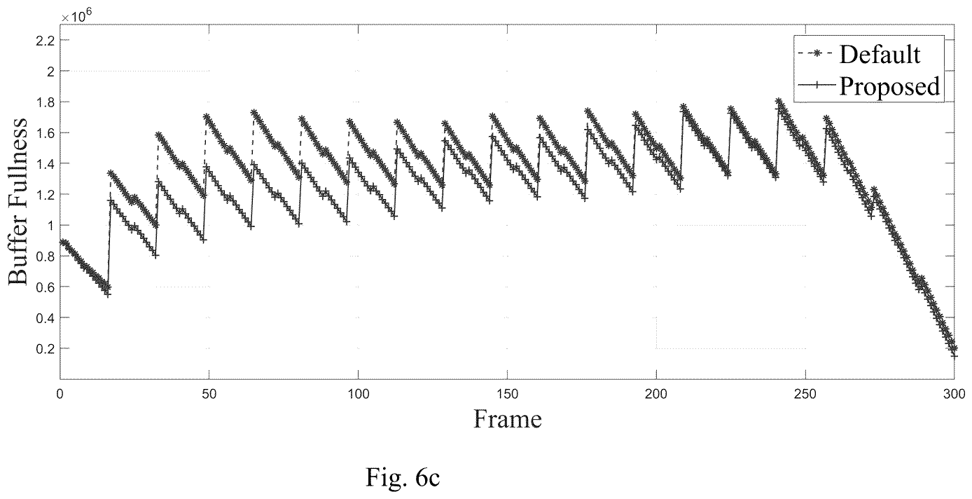

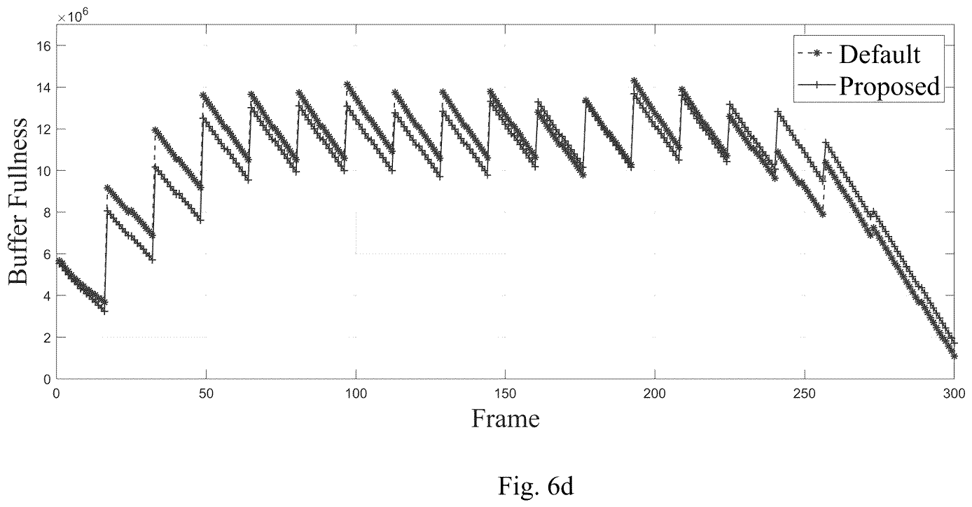

FIGS. 6(a) and 6(b) demonstrate the bit fluctuations of the sequences “DrivingInCity” and “KiteFlite”, where “Bits” is the log 2 form of the actual encoded bits. It shows that the proposed scheme can achieve more stable bit variation. Compared to the default scheme, the proposed scheme saves a few bits in high temporal layer frames and can comparatively increase bits in low temporal layer frames to achieve overall stability. FIGS. 6(c) and 6(d) illustrate the buffer status for the above two sequences. One can find that the proposed scheme has a more stable buffer status compared to the default scheme. More specifically, when there is a fast-moving object in the sequence “DrivingInCity” (between 20 and 200 frames), the buffer of the proposed scheme does not rapidly increase and maintains a lower state. It is more friendly for practical applications of video streaming transmission.

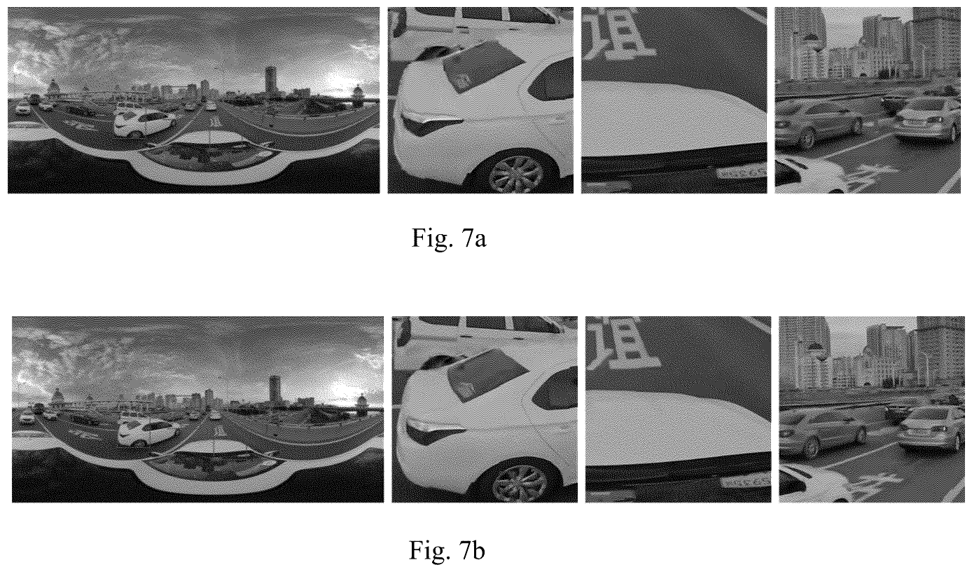

360° videos are typically presented as a sphere model for human eyes. Consequently, the visual perception of 360° videos by human eyes represents a crucial evaluation measure. FIG. 7 depicts the visual quality of the POC 281 from the sequence “DrivingInCity” with the target bitrate of 2490.184 kbps under the LDP configuration. It can be observed that the quality of the proposed scheme's reconstruction of the edge of the white car, located to the left of human eyes, is significantly sharper than that of the default scheme. Simultaneously, in the area in front of human eyes, the road markings of the default scheme appear distorted, while those of the proposed scheme are clearer. Furthermore, the proposed scheme exhibits superior clarity in both the car body and the road signs in the complex traffic situation located on the left front side of the human eyes. A more discernible video of the traffic conditions is of particular importance for human observation and subsequent intelligent analysis of autonomous driving. The initial attribution is to the strip-level bit allocation scheme based on latitude information. According to the characteristics of the ERP format, more weight is given to the equatorial regions to ensure the reasonableness of bit allocation. Furthermore, ScanDMM selects the key viewing regions based on the human eye gaze mechanism and optimizes them at the CTU-level to ensure video quality.

In summary, one can see that an exemplary embodiment of the invention provides a rate control scheme based on human visual gaze mechanism proposed for 360° videos coding. In particular, the latitude information is first extracted to guide a subsequent bit allocation scheme at the strip-level. Scanpath generator (ScanDMM) provides the key CTU indices that correspond to the temporal gaze behavior. Then, an CTU-level λ optimization strategy is developed by using key CTU indices and the distortion relationship of the restructured and current CTUs. Compared with the default rate control scheme in VTM19.0-360Lib13.4 under LDP, LDB, and RA configurations, the proposed rate control scheme obtains BD-rate savings based on WS-PSNR and S-PSNR. The proposed method sheds light on the optimization of the video codec based on the intelligent analysis of 360° video content.

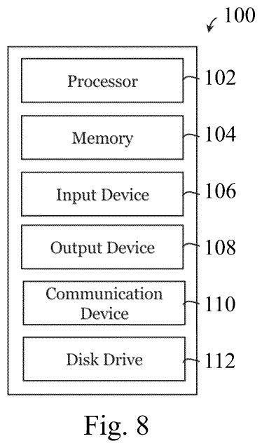

Various method embodiments of the invention may be implemented using system implemented with hardware and/or software. For example, FIG. 8 shows a data processing system 100 in some embodiments of the invention. The data processing system 100 may be used to execute the rate control scheme as described above, and more generally, the data processing system 100 may be used to perform or to facilitate performing of one or more method embodiments of the invention.

The data processing system 100 generally comprises suitable components necessary to receive, store, and execute appropriate computer instructions, data, commands, and/or codes. The main components of the data processing system 100 are a processor 102 and a memory (storage) 104. The processor 102 may include one or more: CPU(s), MCU(s), GPU(s), logic circuit(s), Raspberry Pi chip(s), digital signal processor(s) (DSP), application-specific integrated circuit(s) (ASIC), field-programmable gate array(s) (FPGA), or any other digital or analog circuitry/circuitries configured to interpret and/or to execute program instructions and/or to process signals and/or information and/or data. The memory 104 may include one or more volatile memory (such as RAM, DRAM, SRAM, etc.), one or more non-volatile memory (such as ROM, PROM, EPROM, EEPROM, FRAM, MRAM, FLASH, SSD, NAND, NVDIMM, etc.), or any of their combinations. Appropriate computer instructions, commands, codes, information and/or data may be stored in the memory 104. Computer instructions for executing or facilitating executing the method embodiments of the invention may be stored in the memory 104. The processor 102 and memory (storage) 104 may be integrated or separated (and operably connected).

Optionally, the data processing system 100 further includes one or more input devices 106. Example of such input device 106 include: keyboard, mouse, stylus, image scanner, microphone, tactile/touch input device (e.g., touch sensitive screen), image/video input device (e.g., camera), etc. The input device 106 may be used to receive user input. Optionally, the data processing system 100 further includes one or more output devices 108. Example of such output device 108 include: display (e.g., monitor, screen, projector, etc.), speaker, headphone, earphone, printer, additive manufacturing machine (e.g., 3D printer), etc. The display may include an LCD display, a LED/OLED display, or other suitable display, which may or may not be touch sensitive. The output device 108, e.g., the display, may be used to display the 3D medical image, images of the original slices, images of the reconstructed slices, images of the residual slices, etc. The data processing system 100 may further include one or more disk drives 112 which may include one or more of: solid state drive, hard disk drive, optical drive, flash drive, magnetic tape drive, etc. A suitable operating system may be installed in the data processing system 100, e.g., on the disk drive 112 or in the memory 104. The memory 104 and the disk drive 112 may be operated by the processor 102. Optionally, the data processing system 100 also includes a communication device 110 for establishing one or more communication links (not shown) with one or more other computing devices, such as servers, personal computers, terminals, tablets, phones, watches, IoT devices, or other wireless computing devices. The communication device 110 may include one or more of: a modem, a Network Interface Card (NIC), an integrated network interface, an NFC transceiver, a ZigBee transceiver, a Wi-Fi transceiver, a Bluetooth® transceiver, a radio frequency transceiver, a cellular (2G, 3G, 4G, 5G, above 5G, etc.) transceiver, an optical port, an infrared port, a USB connection, or other wired or wireless communication interfaces. Transceiver may be implemented by one or more devices (integrated transmitter(s) and receiver(s), separate transmitter(s) and receiver(s), etc.). The communication link(s) may be wired or wireless for communicating commands, instructions, information and/or data. In one example, the processor 102, the memory 104 (optionally the input device(s) 106, the output device(s) 108, the communication device(s) 110 and the disk drive(s) 112, if present) are connected with each other, directly or indirectly, through a bus, a Peripheral Component Interconnect (PCI), such as PCI Express, a Universal Serial Bus (USB), an optical bus, or other like bus structure. In one embodiment, at least some of these components may be connected wirelessly, e.g., through a network, such as the Internet or a cloud computing network.

A person skilled in the art would appreciate that the data processing system 100 in FIG. 8 is merely an example and that the data processing system 100 can, in other embodiments, have different configurations (e.g., include additional components, has fewer components, etc.).

Although not required, one or more embodiments described with reference to the Figures can be implemented as an application programming interface (API) or as a series of libraries for use by a developer or can be included within another software application, such as a terminal or computer operating system or a portable computing device operating system. In one or more embodiments, as program modules include routines, programs, objects, components, and data files that assist in the performance of particular functions, the skilled person will understand that the functionality of the software application may be distributed across a number of routines, objects, and/or components to achieve the same functionality desired herein.

The exemplary embodiments are thus fully described. Although the description referred to particular embodiments, it will be clear to one skilled in the art that the invention may be practiced with variation of these specific details. Hence this invention should not be construed as limited to the embodiments set forth herein.

While the embodiments have been illustrated and described in detail in the drawings and foregoing description, the same is to be considered as illustrative and not restrictive in character, it being understood that only exemplary embodiments have been shown and described and do not limit the scope of the invention in any manner. It can be appreciated that any of the features described herein may be used with any embodiment. The illustrative embodiments are not exclusive of each other or of other embodiments not recited herein. Accordingly, the invention also provides embodiments that comprise combinations of one or more of the illustrative embodiments described above. Modifications and variations of the invention as herein set forth can be made without departing from the spirit and scope thereof, and, therefore, only such limitations should be imposed as are indicated by the appended claims.

What is claimed is:

1. A rate control method for 360° videos coding, comprising the steps:
a) converting a 360° video from a sphere domain to a plane domain to obtain two-dimensional (2D) plane video;
b) extracting latitude information from the 2D plane video;
c) adjusting strip-level allocated bits of the 2D plane video with the latitude information; each strip comprising Coding Tree Units (CTUs) in one row;
d) identifying key CTU indices of each frame of the 2D plane video based on gaze points; and
e) optimizing a CTU-level coding parameter based on the key CTU indices and a distortion dependency.

2. The rate control method of claim 1, wherein Step b) further comprises:
f) extracting projection distortion information from conversion in Step a); and
g) deriving the latitude information from the projection distortion information.

3. The rate control method of claim 2, wherein Step a) is conducted during a Equi-rectangular projection (ERP) format process.

4. The rate control method of claim 1, further comprises, before Step c), the step of:
h) allocating strip-level bits according to spatial and temporal features of strips of frames of the 2D plane video.

5. The rate control method of claim 1, wherein Step d) further comprises:
i) providing intra-frames of the 2D plane video to a scanpath prediction model; and
j) obtain key CTUs of each said frame based on locations of the gaze points.

6. The rate control method of claim 1, wherein in Step e) the CTU-level coding parameter is optimized based on a content complexity category and a distortion dependency factor.

7. The rate control method of claim 7, wherein the distortion dependency factor is derived from the comparison between current CTUs and reconstructed CTUs.

8. The rate control method of claim 6, wherein Step e) further comprises, for a given CTU,
k) reducing the CTU-level coding parameter if the given CTU is a key CTU;
l) increasing the CTU-level coding parameter based on the distortion dependency factor if the given CTU is a non-key CTU.

9. The rate control method of claim 1, wherein the CTU-level coding parameter comprises a Lagrange multiplier.

10. The rate control method of claim 1, wherein the CTU-level coding parameter comprises Lagrange multipliers for intra-frames and inter-frames respectively.

11. A non-transitory computer-readable medium, having stored thereon program instructions that, upon execution by a computing device, cause the computing device to perform the method according to claim 1.

12. A computing system comprising:
a) one or more processors; and
b) memory containing instructions that, when executed by the one or more processors, cause the computing system to perform the method according to claim 1.
